(19) United States
(12) Patent Application Publication
(10) Pub. No.: US 2010/0089828 A1
(43) Pub. Date: Apr. 15, 2010

(54) MEMBRANE BIOREACTOR FOR PHOSPHORUS REMOVAL

(76) Inventors: Darren Dale, Derbyshire (GB); Paul M. Gallagher, Hopkinton, MA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/445,691

(22) PCT Filed: Oct. 16, 2007
(86) PCT No.: PCT/US07/22066

§ 371 Date: Dec. 9, 2009

Related U.S. Application Data
(60) Provisional application No. 60/829,727, filed on Oct. 17, 2006.

(51) Int. Cl. C02F 3/02; C02F 3/12

(52) U.S. Cl. 210/631; 210/639; 210/198.1; 210/321.6

(57) ABSTRACT

A method of assisting the removal of phosphorous from wastewater in a wastewater treatment system comprising a membrane bioreactor having at least one membrane (6), the method comprising forming a mixture of a gas and liquid medium; adding a coagulant to the mixture; applying the mixture and added coagulant to a surface of the membrane (6) and filtering a permeate through a wall of the membrane (6).

### TECHNICAL FIELD

The present invention relates to an apparatus and the related method to effectively assist the removal phosphorous in membrane bioreactors by means of a two phase mixture of gas and liquid together with a coagulant.

### BACKGROUND OF THE INVENTION

The importance of membrane for treatment of waste water is growing rapidly. It is now well known that membrane processes can be used as an effective tertiary treatment of sewage and provide quality effluent. However, the capital and operating cost can be prohibitive. With the arrival of submerged membrane processes where the membrane modules are immersed in a large feed tank and filtrate is collected through suction applied to the filtrate side of the membrane, membrane bioreactors combining biological and physical processes in one stage promise to be more compact, efficient and economic. Due to their versatility, the size of membrane bioreactors can range from household (such as septic tank systems) to the community and large-scale sewage treatment.

In processes using gas scouring or scrubbing, a gas is injected, usually by means of a pressurised blower, into a liquid system where a membrane module is submerged to form gas bubbles. The bubbles so formed then travel upwards to scrub the membrane surface to remove the fouling substances formed on the membrane surface. The shear force produced largely relies on the initial gas bubble velocity, bubble size and the resultant of forces applied to the bubbles. The fluid transfer in this approach is limited to the effectiveness of the gas lifting mechanism. To enhance the scrubbing effect, more gas has to be supplied. However, this method has several disadvantages: it consumes large amounts of energy, possibly forms mist or froth flow reducing effective membrane filtration area, and may be destructive to membranes. Moreover, in an environment of high concentration of solids, the gas distribution system may gradually become blocked by dehydrated solids or simply be blocked when the gas flow accidentally ceases.

For most tubular membrane modules, the membranes are flexible in the middle (longitudinal direction) of the modules but tend to be tighter and less flexible towards to both potted heads. When such modules are used in an environment containing high concentrations of suspended solids, solids are easily trapped within the membrane bundle, especially in the proximity of two potted heads: The methods to reduce the accumulation of solids include the improvement of module configurations and flow distribution when gas scrubbing is used to clean the membranes.

In membrane bioreactors employing membrane filters nutrient removal, including phosphorous removal, is often required to produce high quality effluent. Effective phosphorous removal usually requires the use of biological phosphorus removal and chemical phosphorous removal together. Certain types of bioreactor create a vigorous two phase flow of mixed liquor and gas past the membrane modules to enable stable operation of the membrane systems at economically advantageous fluxes.

Chemical phosphorous removal is usually achieved by the precipitation of phosphorous within the mixed liquor by addition of coagulants such as alum, lime or iron salts, and polyelectrolytes. This usually involves the requirement for mixing the coagulants with the mixed liquor in static mixers or separate flash mix tanks. The use of such arrangement adds to the size, complexity and cost of the treatment system.

### DISCLOSURE OF THE INVENTION

The present invention, at least in its embodiments, seeks to overcome or least ameliorate some of the disadvantages of the prior art or at least provide the public with a useful alternative.

According to one aspect, the present invention provides a method of assisting the removal of phosphorous from wastewater in a wastewater treatment system comprising a membrane bioreactor having at least one membrane, the method including the steps of:

forming a mixture of a gas and liquid medium;

adding a coagulant to said mixture;

applying said mixture and added coagulant to a surface of the membrane; and

filtering a permeate through a wall of said membrane.

Preferably, the coagulant is added to the mixture during the mixture forming step.

Preferably, the gas bubbles are entrained into said liquid stream by means of a venturi device. For further preference, the gas bubbles are entrained or injected into said liquid stream by means of devices which forcibly mix gas into a liquid flow to produce a mixture of liquid and bubbles, such devices including a jet, nozzle, ejector, eductor, injector or the like. Preferably the coagulant is added to the mixture at or close to the mixing zone of the gas bubbles and liquid such that the kinetic energy used to form the mixture is also employed to mix the coagulant within the two phase gas/liquid mixture. Optionally, an additional source of bubbles may be provided in said liquid medium by means of a blower or like device. The gas used may include air, oxygen, gaseous chlorine or ozone. Air is the most economical for the purposes of scrubbing, and/or aeration. Gaseous chlorine may be used for scrubbing, disinfection and enhancing the cleaning efficiency by chemical reaction at the membrane surface. The use of ozone, besides the similar effects mentioned for gaseous chlorine, has additional features, such as oxidising DBP precursors and converting non-biodegradable NOM's to biodegradable dissolved organic carbon.

The coagulant may be in the form of alum, lime or iron salts, and polyelectrolytes.

According to a second aspect, the present invention provides a membrane module comprising a plurality of porous membranes, means for providing, from within the module, by means other than gas passing through the pores of said membranes, a mixture of gas bubbles entrained in a liquid flow and a coagulant, such that, in use, said liquid, the bubbles entrained therein and coagulant move past the surfaces of said membranes to dislodge fouling materials therefrom, said gas bubbles being entrained in said liquid by flowing said liquid past a source of gas to draw the gas into said liquid flow.

According to one preferred form, the present invention provides a method of removing phosphorous in a bioreactor including a plurality of porous membranes forming a membrane module, the method comprising the steps of:

providing, from within said module, by means other than gas passing through the pores of said membranes, uniformly distributed gas bubbles entrained in a liquid flow, said gas bubbles being entrained in said liquid flow by flowing said liquid past a source of gas so as to cause said gas to be drawn and/or mixed into said liquid to form a two phase mixture;

mixing a coagulant with the two phase mixture; and

applying said mixture to said porous hollow membranes.

Preferably, said bubbles are injected and mixed into said liquid flow.

For preference, the membranes comprise porous hollow fibres, the fibres being fixed at each end in a header, the lower header having one or more openings formed therein through which gas/liquid flow is introduced. The openings can be circular, elliptical or in the form of a slot. The fibres are normally sealed at the lower end and open at their upper end to allow removal of filtrate, however, in some arrangements, the fibres may be open at both ends to allow removal of filtrate from one or both ends. The fibres are preferably arranged in cylindrical arrays or bundles. It will be appreciated that the cleaning process described is equally applicable to other forms of membrane such flat or plate membranes.

The fibre bundle is protected and fibre movement is limited by a module support screen which has both vertical and horizontal elements appropriately spaced to provide unrestricted fluid and gas flow through the fibres and to restrict the amplitude of fibre motion reducing energy concentration at the potted ends of the fibres.

For preference, said openings comprise a slot, slots or a row of holes. Preferably, the fibre bundles are located in the potting head between the slots or rows of holes.

For further preference, the gas bubbles are entrained or mixed with a liquid flow before being fed through said holes or slots, though it will be appreciated that gas only may be used in some configurations. The liquid used may be the feed to the membrane module. Preferably, the fibres within the module have a packing density (as defined above) of between about 5 to about 70% and, more preferably, between about 8 to about 55%.

For preference, said holes have a diameter in the range of about 1 to 40 mm and more preferably in the range of about 1.5 to about 25 mm. In the case of a slot or row of holes, the open area is chosen to be equivalent to that of the above holes.

Typically, the fibre inner diameter ranges from about 0.1 mm to about 5 mm and is preferably in the range of about 0.25 mm to about 2 mm. The fibres wall thickness is dependent on materials used and strength required versus filtration efficiency. Typically wall thickness is between 0.05 to 2 mm and more often between 0.1 mm to 1 mm.

According to another aspect, the present invention provides a membrane bioreactor including a tank having means for the introduction of feed thereto, means for forming activated sludge within said tank, a membrane module according to the second aspect positioned within said tank so as to be immersed in said sludge and said membrane module provided with means for withdrawing filtrate from at least one end of said fibre membranes.

According to yet another aspect, the present invention provides a method of operating a membrane bioreactor of the type described in the third aspect comprising introducing feed to said tank, applying a vacuum to said fibres to withdraw filtrate therefrom while periodically or continuously supplying gas bubbles through said aeration openings to within said module such that, in use, said bubbles move past the surfaces of said membrane fibres to dislodge fouling materials therefrom. Preferably, the gas bubbles are entrained or mixed with a liquid flow and a coagulant when fed through said holes or slots.

If required, a further source of aeration may be provided within the tank to assist microorganism activity. For preference, the membrane module is suspended vertically within the tank and said further source of aeration may be provided beneath the suspended module. Preferably, the further source of aeration comprises a group of air permeable tubes: The membrane module may be operated with or without backwash depending on the flux. A high mixed liquor of suspended solids (5,000 to 20,000 ppm) in the bioreactor has been shown to significantly reduce residence time and improve filtrate quality. The combined use of aeration for both degradation of organic substances and membrane cleaning has been shown to enable constant filtrate flow without significant increases in transmembrane pressure while establishing high concentration of MLSS. The use of chemical phosphorous removal in combination with the biological phosphorous removal provided by the membrane bioreactor further increase the overall effectiveness of phosphorous removal for the system.

### BRIEF DESCRIPTION OF THE DRAWINGS

Preferred embodiments of the invention will now be described, by way of example only, with reference to the accompanying drawings in which:—

FIG. 1 shows a schematic side elevation of one embodiment of a membrane module and illustrates the method of cleaning according to the invention; and

FIG. 2 shows an enlarged schematic side elevation of one form of the jet type arrangement used to form entrained gas bubbles.

### PREFERRED EMBODIMENTS OF THE INVENTION

Referring to the drawings, the embodiments of the invention will be described in relation to a membrane module of the type disclosed in our earlier PCT application No. WO98/28066 (which is incorporated herein in its entirety by cross-reference) when used in a membrane bioreactor system, however, it will be appreciated that the invention is equally applicable to other forms of membrane module and/or membrane bioreactor.

The membrane module 5 typically comprises fibre, tubular or flat sheet form membranes 6 potted at two ends 7 and 8 and encased in a support structure, in this case a screen 9. Either one or both ends of the membranes may be used for the permeate collection. The bottom of the membrane module has a number of through apertures 10 in the pot 11 to distribute a mixture of gas and liquid feed past the membrane surfaces.

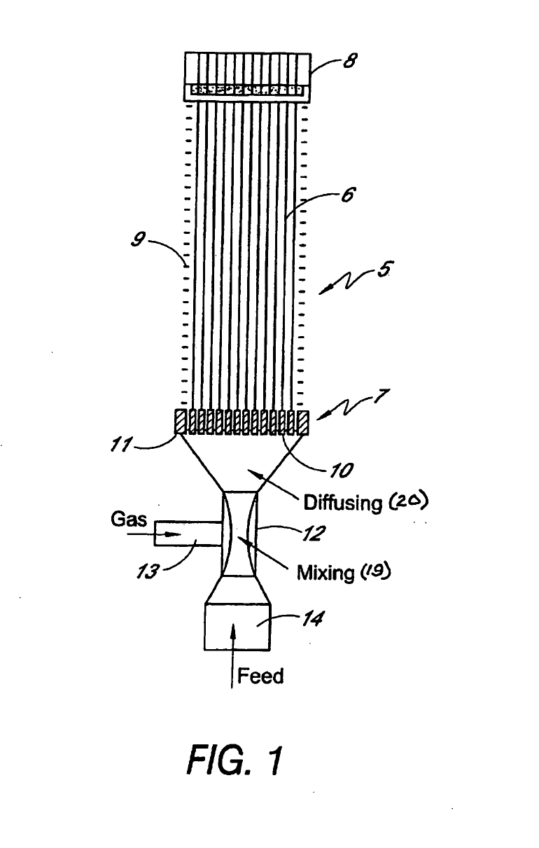

Referring to the embodiment shown in FIG. 1, a venturi device 12 or the like is connected to the base of the module. The venturi device 12 intakes gas through inlet 13, mixes or entrains the gas with liquid flowing through feed inlet 14, forms gas bubbles and diffuses the liquid/gas mix into the module apertures 10. Coagulant chemicals may be mixed with the liquid gas mixture in the mixing zone 19 and/or the diffusing zone 20. After passing through the distribution apertures 10, the entrained gas bubbles scrub membrane surfaces while travelling upwards along with the liquid flow. Either the liquid feed or the gas can be a continuous or intermittent injection depending on the system requirements. With a venturi device it is possible to create gas bubbles and aerate the system without a blower. The venturi device 12 can be a venturi tube, jet, nozzle, ejector, eductor, injector or the like.

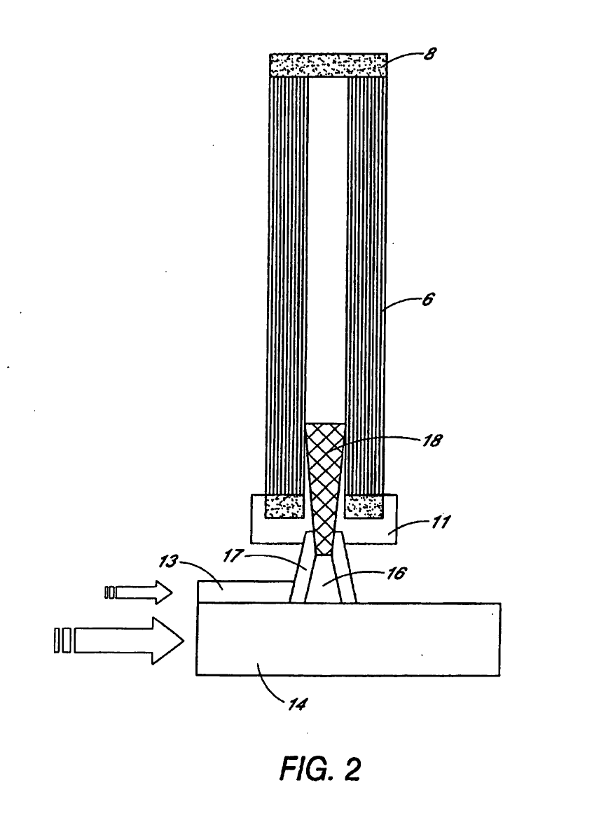

Referring to FIG. 2, an enlarged view of jet or nozzle type device 15 is shown. In this embodiment, liquid is forced through a jet 16 having a surrounding air passage 17 to produce a gas entrained liquid flow 18. Such a device allows the independent control of gas and liquid medium by adjusting respective supply valves. Coagulant chemicals may be added and/or mixed into the gas/liquid flow 18.

The liquid commonly used to entrain the gas is the feed water, wastewater or mixed liquor to be filtered. Pumping such an operating liquid through a venturi or the like creates a vacuum to suck the gas into the liquid, or reduces the gas discharge pressure when a blower is used. By providing the gas in a flow of the liquid, the possibility of blockage of the distribution apertures 10 is substantially reduced.

The present invention at least in its preferred embodiments may provide a number of advantages which may be summarised as follows:

The use of kinetic energy generated by the formation to the two-phase gas/liquid mixture to rapidly and intimately mix a coagulant into the mixed liquor flow optimizes coagulant usage and phosphorus removal.

The arrangement described provides a means for introducing a coagulant flow into the mixing zone below the modules where gas flow and mixed liquor flow are contacted vigorously to generate a two-phase fluid flow. This avoids the need for static mixers or separate flash mix tanks while ensuring that the coagulant is dispersed instantaneously into the mixed liquor flow.

The injection arrangement further provides an efficient cleaning mechanism for introducing cleaning chemicals effectively into the depths of the module while providing scouring energy to enhance chemical cleaning.

The positive injection of a mixture of gas, liquid feed and coagulant to each membrane module provides a uniform distribution of process fluid around membranes and therefore minimises the feed concentration polarisation during filtration. The concentration polarisation is greater in a large-scale system and for the process feed containing large amounts of suspended solids. The prior art systems have poor uniformity because the process fluid often enters one end of the tank and concentrates as it moves across the modules. The result is that some modules deal with much higher concentrations than others resulting in inefficient operation.

Such a method can be used to the treatment of drinking water, wastewater and the related processes by membranes. The filtration process can be driven by suction or pressurisation.

Air is preferably introduced into the module continuously to provide oxygen for microorganism activities and to continuously scour the membranes. Alternatively, in some applications, pure oxygen or other gas mixtures may be used instead of air. The clean filtrate is drawn out of the membranes by a suction pump attached to the membrane lumens which pass through the upper pot as described in our earlier aforementioned application.

Preferably, the membrane module is operated under low transmembrane pressure (TMP) conditions because of the high concentration of suspended solids (MLSS) present in the reactor.

The membrane bioreactor is preferably combined with an anaerobic process which assists with further removal of nutrients from the feed sewage.

It has been found that the module system employed is more tolerant of high MLSS than many present systems and the efficient air scrub and back wash (when used) assists efficient operation and performance of the bioreactor module.

It will be appreciated that, although the invention and embodiments have been described in relation to an application to bioreactors and like systems, the invention may be equally applicable to other types of application.

It will be appreciated that the invention is not limited to the specific embodiments described and other embodiments and exemplifications of the invention are possible without departing from the sprit or scope of the invention.

1. A method of assisting the removal of phosphorous from wastewater in a wastewater treatment system comprising a membrane bioreactor having at least one membrane, the method comprising the steps of:
forming a mixture of a gas and liquid medium;
adding a coagulant to the mixture;
applying the mixture and added coagulant to a surface of the membrane; and
filtering a permeate through a wall of the membrane.

2. The method according to claim 1, wherein the coagulant is added to the mixture during the mixture forming step.

3. The method according to claim 1, comprising entraining the gas into the liquid medium by means of a venturi device.

4. The method according to claim 1, comprising entraining or injecting the gas into the liquid medium by a device which forcibly mixes gas into a liquid flow to produce a mixture of liquid and gas.

5. The method according to claim 4, wherein the device includes one or more of the following: a jet, nozzle, injector, ejector or eductor.

6. The method according to claim 1, further comprising the step of adding the coagulant to the mixture at or close to the mixing zone of the gas and liquid medium such that the kinetic energy used to form the mixture is also employed to mix the coagulant within the two phase gas/liquid mixture.

7. The method according to claim 1, further comprising the step of providing an additional source of gas in said liquid medium by means of a blower.

8. The method according to claim 7, wherein the gas includes one or more of the following: air, oxygen, gaseous chlorine or ozone.

9. The method according to claim 1, wherein the coagulant includes one or more of the following: alum, lime or iron salts, or polyelectrolytes.

10. A membrane module comprising:
a plurality of porous membranes; and
means for providing, from within the module, by means other than gas passing through the pores of said membranes, a mixture of gas bubbles entrained in a liquid flow and a coagulant, such that, in use, the liquid, the bubbles entrained therein and coagulant move past the surfaces of the membranes to dislodge fouling materials therefrom, the gas bubbles being entrained in the liquid by flowing the liquid past a source of gas to draw the gas into the liquid flow.

11. A membrane module according to claim 10, wherein the membranes comprise porous hollow fibres, the fibres being fixed at each end in a header, the lower header having one or more openings formed therein through which gas/liquid flow is introduced.

12. The membrane module of claim 11, wherein the openings are circular, elliptical or in the form of a slot.

13. The membrane module of claim 11, wherein openings comprise a slot, slots or a row of holes.

14. The membrane module of claim 13, wherein the fibre membranes are arranged in bundles and the fibre membrane bundles are located in the lower header between the slots or rows of holes.

15. The membrane module of claim 11, wherein the fibres within the module have a packing density of between about 5 to about 70%.

16. The membrane module of claim 15, wherein the fibres within the module have a packing density of between about 8 to about 55%.

17. The membrane module of claim 11, wherein the openings have a diameter in the range of about 1 to 40 mm.

18. The membrane module of claim 17, wherein the openings have a diameter in the range of about 1.5 to about 25 mm.

19. The membrane module of claim 11, wherein the fibre inner diameter ranges from about 0.1 mm to about 5 mm.

20. The membrane module of claim 19, wherein the fibre inner diameter ranges from about 0.25 mm to about 2 mm.

21. The membrane module of claim 19, wherein the fibre wall thickness is between approximately 0.05 to 2 mm.

22. A method of removing phosphorous in a bioreactor including a plurality of porous membranes forming a membrane module, the method comprising the steps of:
providing, from within the module, by means other than gas passing through the pores of the membranes, uniformly distributed gas bubbles entrained in a liquid flow, the gas bubbles being entrained in the liquid flow by flowing the liquid past a source of gas so as to cause the gas to be drawn and/or mixed into the liquid to form a two phase mixture;
mixing a coagulant with the two phase mixture; and
applying the mixture to the porous hollow membranes.

23. A method according to claim 22, wherein the bubbles are injected and mixed into the liquid flow.

24. A method according to claim 22, wherein the liquid used is feed liquid to the membrane module.

25. A membrane bioreactor comprising:
a tank having means for the introduction of feed thereto;
means for forming activated sludge within the tank; and
a membrane module positioned within the tank so as to be immersed in the sludge and the membrane module provided with means for withdrawing filtrate from at least one end of the fibre membranes.

26. A method of operating a membrane bioreactor of the type according to claim 24, further comprising the steps of introducing feed to the tank, applying a vacuum to the fibres to withdraw filtrate therefrom while periodically or continuously supplying gas bubbles through the aeration openings to within the module such that, in use, the bubbles move past the surfaces of the membrane fibres to dislodge fouling materials therefrom.

27. The method of claim 26, further comprising the step of entraining or mixing the gas bubbles with a liquid flow and a coagulant when fed through the aeration openings.

28. The method according to claim 26, further comprising the step of providing a further source of aeration within the tank to assist microorganism activity.

29. The method according to claim 28, wherein the membrane module is suspended vertically within the tank and the further source of aeration is provided beneath the suspended module.

30. The method according to claim 28, wherein the further source of aeration comprises a group of air permeable tubes.
